(19) United States
(12) Patent Application Publication
(10) Pub. No.: US 2008/0204204 A1
(43) Pub. Date: Aug. 28, 2008

(54) Position Sensor for the Seat of a Motor Vehicle

(76) Inventors: Bruno Farelli, Rosta (TO) (IT); Cesare Farelli, Cumiana (TO) (IT)

Correspondence Address: MERCHANT & GOULD PC, P.O. BOX 2903, MINNEAPOLIS, MN, 55402-0903, US

(21) Appl. No.: 11/917,891

(22) PCT Filed: Jun. 19, 2006
(86) PCT No.: PCT/EP2006/005836

§ 371 Date: Dec. 17, 2007

(30) Foreign Application Priority Data
Jun. 22, 2005 (IT) TO2005U000084

(51) Int. Cl. B60Q 1/00; B60R 21/01

(52) U.S. Cl. 340/425.5

(57) ABSTRACT

A sensor (8) for the backrest of the seat of a motor vehicle, designed to control the position of the back of the occupant, is made up of a shell (9) of contained thickness, preferably made of plastic material, connectable via wire means (5) to the supporting bars (3) of the headrest (2), and provided at the front with a part (12, 15) associated to means (16, 19) for activation of an alarm device (18, 21).

The present invention relates to a sensor for verifying the correct position of the driver or passenger in the seat of a motor vehicle. Said sensor is not permanently fixed to the seat but can be transferred from one vehicle to another with extreme ease.

Frequently, the position assumed by drivers and passengers in the seats of motor vehicles is not correct from the standpoint of the integrity of the vertebral column. In fact, the position of the backrest should be kept as vertical as possible and the back of the driver and/or passenger should adhere to the backrest as snugly as possible since the shape of the backrest is designed so as to present the best possible resting surface. This condition, however, is very rarely satisfied, with the consequences that can be readily imagined. On the other hand, even though the backrest of the seat of a motor vehicle is shaped in an ergonomic way, automobile manufacturers fail to provide the seat with sensors that are able to indicate to the driver or passenger that his or her position is not correct.

The purpose of the present invention is to make up for said deficiency and to help the driver or passenger to maintain the correct position on the seat.

The above purpose is achieved by the present invention, the subject of which is a sensor for the seat of a motor vehicle that has the characteristics specified in Claim 1.

Further characteristics and advantages will emerge clearly from the ensuing description with reference to the attached plate of drawings, which are provided purely by way of non-limiting example and in which:

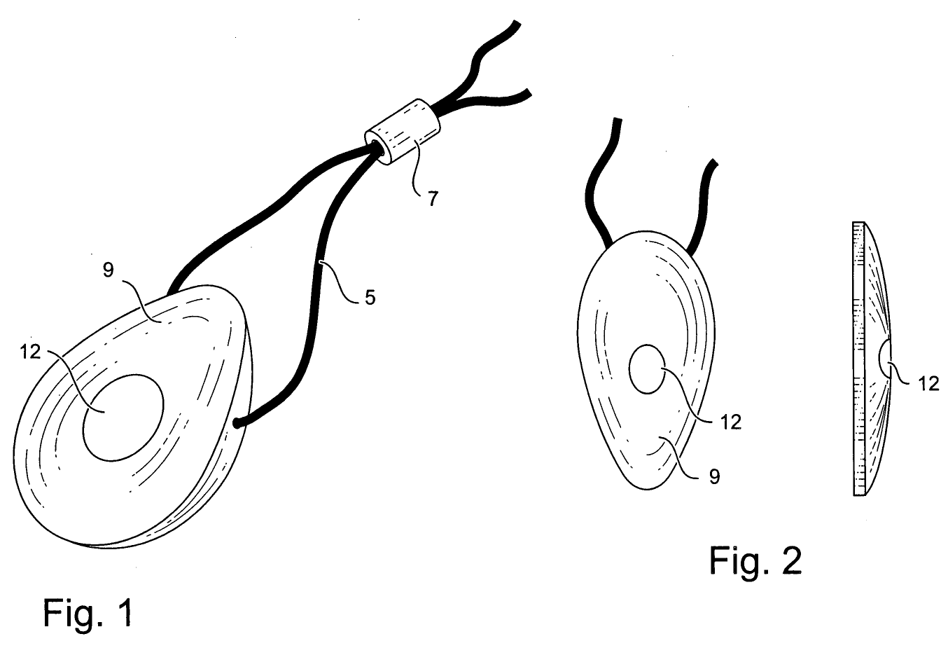

FIG. 1 is a perspective view of the sensor according to the invention, which includes a positioning cord;

FIG. 2 shows two views (front and side) of a sensor according to the invention having a different shape from that of FIG. 1;

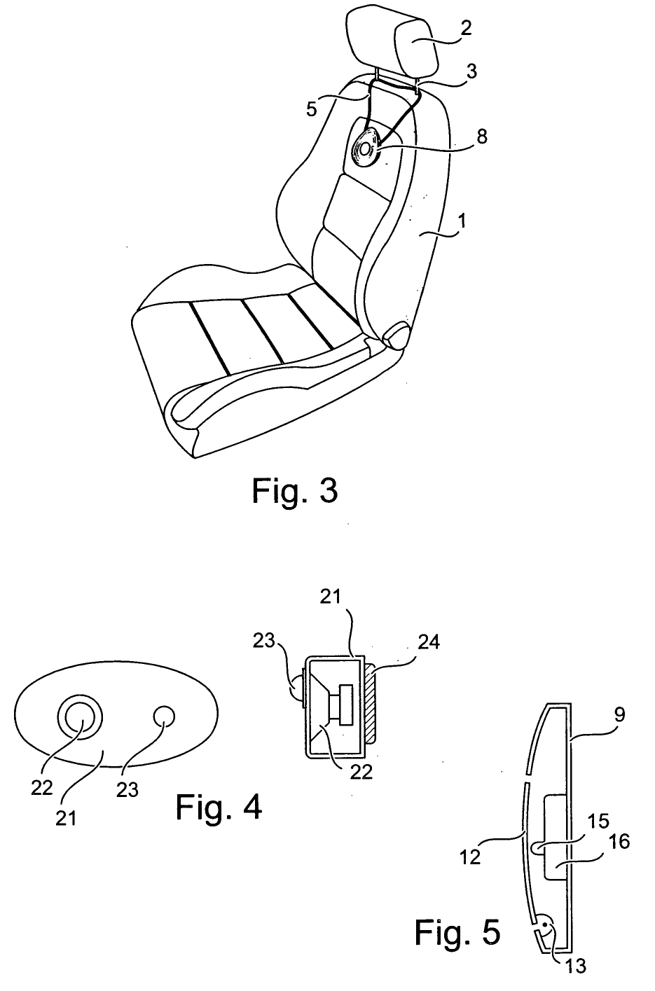

FIG. 3 is a view of the sensor according to the invention positioned on the seat of a motor vehicle;

FIG. 4 shows two views (a front view and a lateral cross-sectional view) of an acoustic and visual alarm connected via radio to the sensor according to the invention.

FIG. 5 is a lateral cross-sectional view of an embodiment of the sensor according to the invention;

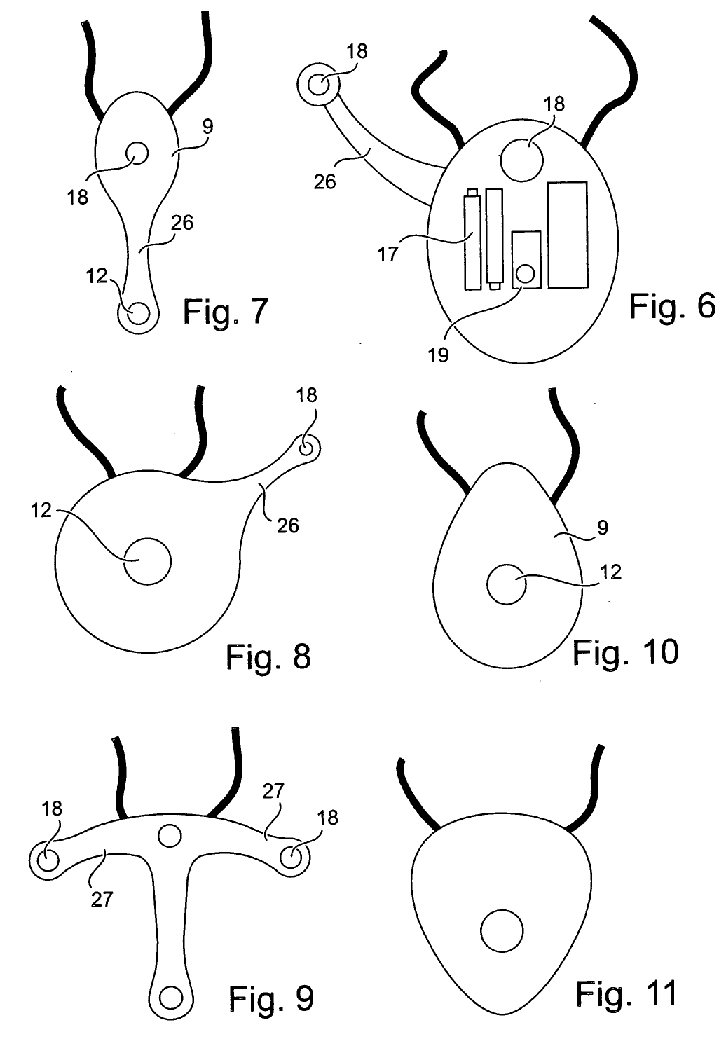

FIG. 6 is a front view, in partial transparency, of a particular embodiment of the sensor according to the invention; and

FIGS. 7 to 11 are front views of different embodiments of the invention.

With reference to the figures, the number 1 designates the backrest of the seat of a motor vehicle, provided with a headrest 2 supported by bars 3 inserted in the backrest 1. A loop of cord 5 provided with a tube 7 for adjustment of the amplitude of the loop is fitted around the supporting bars.

Fitted on the loop of cord 5 is the sensor 8 according to the invention, which is constituted by a casing or shell 9 of contained thickness, preferably made of plastic material, having a substantially circular profile in its the basic version.

Illustrated in FIGS. 7 to 11 are other geometrical shapes that the shell may assume, without this implying any departure from the sphere of protection of the present invention.

A more detailed description of some of these shapes will be furnished in the course of the ensuing description. The shell 9 is provided with a part of front wall 12 that is compressible in so far as it is, for example, connected by a hinge made of plastic film 13 to the remaining part of the shell. The film-type hinge represents one possible solution designed to enable displacement of the part 12 of wall. Other equivalent known solutions, such as for example a part of bellows-like wall, may conveniently be adopted by the manufacturer.

In its movement, the part of wall 12 is designed to press the push-button 15 of a microswitch 16, set within the shell 9 and supplied by batteries 17. The push-button 15 may also emerge from the surface of the shell 9 and replace the compressible part of wall 12 altogether.

The microswitch is designed to activate an audible alarm 18 in the case where the pressure thereon ceases, of course after the sensor has been activated via an on-off switch (not illustrated).

The pressure microswitch may, according to the model of sensor, be replaced by a proximity sensor (19) or else by a presence detector (not illustrated), appropriately calibrated for detecting the presence of the occupant of the seat at an adequate distance, for example between 0 mm and 10 mm.

As in the case of the microswitch, the absence of the occupant will trigger sending of a signal to the audible alarm 18 and/or to a receiver 21, provided both with an acoustic signal 22 and with a luminous signal 23 set in front of the occupant of the seat and held in position by known means, for example bi-adhesive tape 24.

As mentioned previously, in some embodiments the acoustic alarm provided on the sensor 8 is supported by an arm 26 (FIGS. 6-8) or by a number of arms 27 (FIG. 9).

The sensor 8 according to the invention has the essential task of sending a signal when the occupant of the seat bends his or her back forwards so as to prevent the occupant from assuming wrong positions. Furthermore, the sensor 8 can also represent a valid anti-drowse device. Use of the sensor is very convenient in so far as it hangs with the cord 5 from the headrest 2 in a position that approximately corresponds to the base of the neck of the occupant. The position may moreover be adjusted by sliding the tube 7 along the cord 5.

1) A sensor for the backrest of the seat of a motor vehicle, designed to control the position of the back of the occupant, comprising a shell of contained thickness, connectable via wire means to the supporting bars of the headrest, and provided at the front with a part associated to means for activation of an alarm device.

2) The sensor according to claim 1, wherein the activation means comprise a pressure microswitch of the normally open type.

3) The sensor according to claim 1, wherein the activation means comprise a proximity sensor.

4) The sensor according to claim 1, wherein the activation means comprise a presence sensor.

5) The sensor according to claim 1, wherein the alarm device comprises an acoustic alarm.

6) The sensor according to claim 1, wherein the alarm device is of the visual/acoustic type and comprises a warning light and by an audible alarm.

7) The sensor according to claim 1, wherein the alarm device is positioned in front of the occupant of the seat.

8) The sensor according to claim 1, wherein the wire means are adjustable in length.

9) The sensor according to claim 1, wherein the shell comprises a plastic material.
